(19) United States
(12) Patent Application Publication
(10) Pub. No.: US 2024/0346624 A1
(43) Pub. Date: Oct. 17, 2024

(54) ASYMMETRIC IMAGE FUSION METHOD AND THE RELATED OPERATION DEVICE

(71) Applicant: MEDIATEK INC., Hsin-Chu (TW)

(72) Inventors: Chi-Cheng Ju, Hsinchu City (TW); Ying-Jui Chen, Hsinchu City (TW); Jing-Ying Chang, Hsinchu City (TW); Shan-Lung Chao, Hsinchu City (TW)

(73) Assignee: MEDIATEK INC., Hsin-Chu (TW)

(21) Appl. No.: 18/637,468

(22) Filed: Apr. 17, 2024

Related U.S. Application Data
(60) Provisional application No. 63/496,439, filed on Apr. 17, 2023.

(51) Int. Cl. G06T 5/50

(52) U.S. Cl. CPC G06T 5/50; G06T 2207/20221

(57) ABSTRACT

An asymmetric image fusion method is applied to an operation device and includes acquiring a first image stream with a first frame rate, acquiring a second image stream with a second frame rate different from the first frame rate, and fusing a first reused image frame of the first image stream with a set of second image frames of the second image stream respectively for outputting a set of fused image frames.

### CROSS REFERENCE TO RELATED APPLICATIONS

This application claims the benefit of U.S. Provisional Application No. 63/496,439, filed on Apr. 17, 2023. The content of the application is incorporated herein by reference.

### BACKGROUND

The conventional high dynamic range (HDR) video technology based on multiple frame fusion is designed to fuse multiple frames with different exposure setting for producing one output frame, and the multiple frames are from image streams with the same frame rate. For example, one image stream has a plurality of first input frames marked as F1(1), F1(2), . . . , F1(N), and another image stream has a plurality of second input frames marked as F2(1), F2(2), . . . , F2(N). the foresaid two image streams have the same frame rate. Each of the first input frames and one corresponding frame of the second input frames are merged to generate a plurality of output frames marked as O(1), O(2), . . . , O(N). Therefore, the number of the input frames being 2N is required to generate the output frames with the number of N. The large number of the input frames causes high power consumption during sensing, transmission or storing procedures, so design of a multiple image fusion method capable of reducing a number of the input frame in image fusion is an important issue in the HDR video technology.

### SUMMARY

The present invention provides an asymmetric image fusion method of economizing the power consumption of sensing, transmission or storing the captured image frames and a related operation device for solving above drawbacks.

According to the claimed invention, an asymmetric image fusion method includes acquiring a first image stream with a first frame rate, acquiring a second image stream with a second frame rate different from the first frame rate, and fusing a first reused image frame of the first image stream with a set of second image frames of the second image stream respectively for outputting a set of fused image frames. The asymmetric image fusion method further includes fusing another first reused image frame of the first image stream with another set of second image frames of the second image stream respectively for outputting another set of fused image frames, and combining the foresaid sets of fused image frames to provide an output image stream.

According to the claimed invention, the second frame rate of the second image stream is equal to an output frame rate of the output image stream, the first frame rate is variable, an exposure setting of the first image stream is different from an exposure setting of the second image stream, and a reused frequency of the first reused image frame is the same as a reused frequency of the another first reused image frame.

According to the claimed invention, the asymmetric image fusion method further includes acquiring a third image stream with a third frame rate different from the first frame rate and the second frame rate, and fusing the first reused image frame of the first image stream and a third reused image frame of the third image stream with the set of second image frames of the second image stream respectively for outputting the set of fused image frames. A reused frequency of the first reused image frame is different from a reused frequency of the third reused image frame.

According to the claimed invention, the asymmetric image fusion method further includes fusing the first reused image frame with a current second image frame of the set of second image frames to output a current fused image frame of the set of fused image frames, and fusing the first reused image frame with a following second image frame of the set of second image frames to output a following fused image frame of the set of fused image frames and delaying for showing the following fused image frame after a predefined period.

According to the claimed invention, the asymmetric image fusion method further includes fusing the first reused image frame with a previous second image frame of the set of second image frames to output a previous fused image frame of the set of fused image frames and delaying for showing the previous fused image frame after a predefined period, and fusing the first reused image frame with a current second image frame of the set of second image frames to output a current fused image frame of the set of fused image frames and delaying for showing the current fused image frame after another predefined period.

According to the claimed invention, the asymmetric image fusion method further includes changing the first frame rate to be equal to an output frame rate of the output image stream, changing the second frame rate to be different from the output frame rate, and fusing a second reused image frame of the second image stream with a set of first image frames of the first image stream respectively for outputting other set of fused image frames.

According to the claimed invention, an operation device with an asymmetric image fusion function includes an operation processor electrically connected with an image sensor to acquire a first image stream with a first frame rate and a second image stream with a second frame rate different from the first frame rate, and adapted to fuse a first reused image frame of the first image stream with a set of second image frames of the second image stream respectively for outputting a set of fused image frames.

The asymmetric image fusion method and the related operation device of the present invention can acquire at least two image streams with different frame rate and different exposure settings. Each reused image frame of the image stream that is set to the reference exposure setting can be fused with several image frames of the image stream that is set to the base exposure setting for providing the output image stream. The first image stream may have 15 fps and the second image stream may have 30 fps; the second frame rate of the second image stream must keep the same frame rate as display requirement of the output image stream. Therefore, the even or odd indexing of the first reused image frame can be shared and fused with the corresponding second image frames to produce the fused image frames of the output image stream. The number of the first image frames can be reduced to economize the power consumption of sensing, transmission or storing the captured image frames.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an operation device according to an embodiment of the present invention.

FIG. 2 is a flow chart of an asymmetric image fusion method according to the embodiment of the present invention.

FIG. 3 is a diagram of showing the image streams with different frame rates and different exposure settings according to a first embodiment of the present invention.

FIG. 4 is a diagram of showing the image streams with different frame rates and different exposure settings according to a second embodiment of the present invention.

FIG. 5 is a diagram of showing the image streams with different frame rates and different exposure settings according to a third embodiment of the present invention.

FIG. 6 is a diagram of showing the image streams with different frame rates and different exposure settings according to a fourth embodiment of the present invention.

FIG. 7 is a diagram of showing the image streams with different frame rates and different exposure settings according to a fifth embodiment of the present invention.

### DETAILED DESCRIPTION

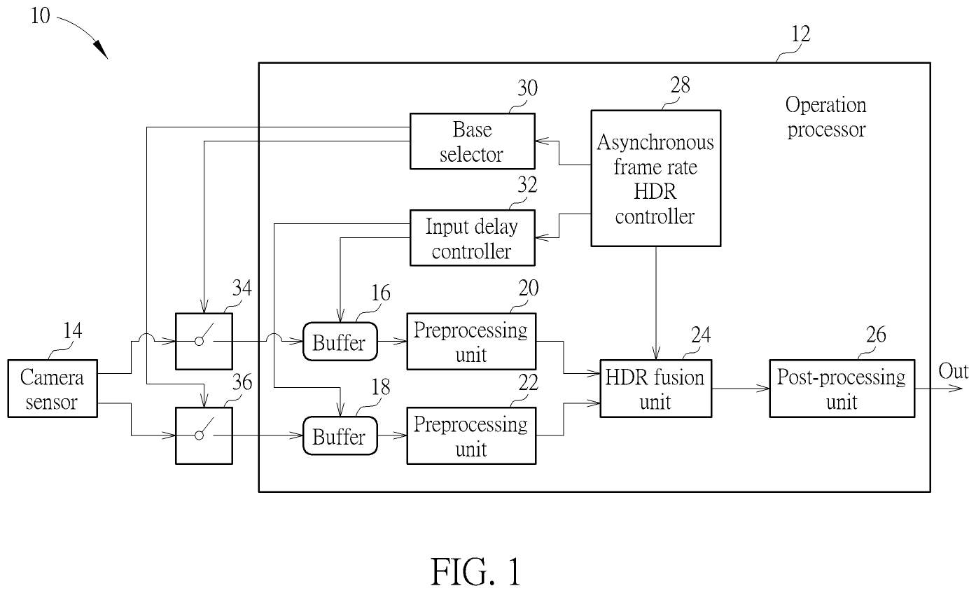

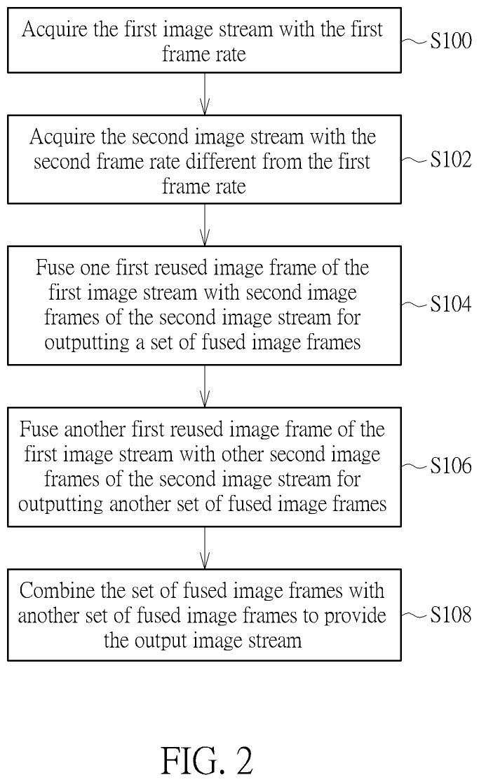

Please refer to FIG. 1 and FIG. 2. FIG. 1 is a functional block diagram of an operation device 10 according to an embodiment of the present invention. FIG. 2 is a flow chart of an asymmetric image fusion method according to the embodiment of the present invention. The operation device 10 can include an operation processor 12 electrically connected to a camera sensor 14 in a wired manner or in a wireless manner. The operation device 10 can utilize image streams captured by the camera sensor 14 to execute the asymmetric image fusion method illustrate in FIG. 2. In other possible embodiment, the operation device 10 may be a built-in unit of the camera sensor 14. Application of the operation device 10 and the camera sensor 14 can depend on a design demand.

The camera sensor 14 can be one or several high-speed camera sensors that can capture frames in high speed, or can be a group exposure setting camera sensor that has group exposure setting designed for HDR; types of the camera sensor 14 are not limited to the foresaid embodiment, and depends on the design demand. The camera sensor 14 can provide a plurality of image streams (or called streams with multiple images or video streams) with different frame rates and different exposure settings. The different exposure settings may be different exposure time or different sensor gains, which depends on the design demand. The longer exposure time or the higher sensor gain can cause a bright area within the image frame be clipped in a sensor output value range. The shorter exposure time or the lower sensor gain can cause a low signal to noise ratio (S/N) in a dark area within the image frame.

Therefore, the operation processor 12 can execute the asymmetric image fusion method to fuse the plurality of image streams with different frame rates and different exposure settings by reusing some image frames of the image streams, so as to output an output image stream or stream with images or video stream via HDR technology, for providing advantages of reducing a number of the captured image frames and economizing power consumption of sensing, transmission or storing the captured image frames. In the embodiment, the exposure settings of the image streams with different frame rates can be dynamically controlled by an auto-exposure algorithm, so the exposure setting of each image stream may not be a fixed value.

In an example of the camera sensor 14 providing two image streams with different frame rates and different exposure settings, the operation processor 12 may optionally have buffers 16 and 18, preprocessing units 20 and 22, a HDR fusion unit 24, a post-processing unit 26, an asynchronous frame rate HDR controller 28, a base selector 30 and an input delay controller 32. The buffers 16 and 18 can be used to change an image read rate. The preprocessing units 20 and 22, the HDR fusion unit 24 and the post-processing unit 26 can be applied according to standard HDR process. The asynchronous frame rate HDR controller 28 can be designed to adjust the frame rate of the image stream output by the camera sensor 14. The base selector 30 can be designed to control different exposure settings of the switches 34 and 36 at every point of times. The input delay controller 32 can be designed to control a delayed period of each image stream through the buffer 16 and/or 18.

In the present invention, one of the two image streams can have a base exposure setting, and the other image stream can have a reference exposure setting. The image stream with the base exposure setting can product required motion of the output image stream, such as the child running, the tree swinging, the camera panning, and so on. The frame rate of the image stream with the base exposure setting can be fixed to keep the same as a display speed of the output image stream. The frame rate of the image stream with the reference exposure setting can be reduced to reduce the power consumption (in other words, the frame rate of the image stream with the reference exposure setting is set to be less than the frame rate of the display speed of the output image stream). It should be mentioned that the frame rate of the image stream with the reference exposure setting does not need to be kept uniform, and can be changed in accordance with a reduction goal of the power consumption.

In some specific condition, the base exposure setting of one image stream can be changed to the reference exposure setting, and the reference exposure setting of the other image stream can be changed to the base exposure setting via the asymmetric image fusion method of the present invention, because the base exposure setting can be controlled depending on scenes or recording purposes. For example, the image stream that has long exposure frame (with the longer exposure time or the higher sensor gain) can be set as the base exposure setting when the camera sensor 14 needs the better S/N; an external motion sensor may be used to compensate motion between the long exposure frame and short exposure frame. Or, the image stream that has the short exposure frame (with the shorter exposure time or the lower sensor gain) can be set as the base exposure setting when the camera sensor 14 is used in the mobile phone for recording the child running.

The foresaid example introduces the 2-exposure fusion, and an actual application is not limited to the 2-exposure fusion and can be expanded to the 3-exposure fusion. In other example of the camera sensor 14 providing three or more than three image streams with different frame rates and different exposure settings, one of the image streams that has the base exposure setting can have the frame rate identical to the display speed of the output image stream, and other image streams having the reference exposure setting can have the frame rate different from the display speed of the output image stream.

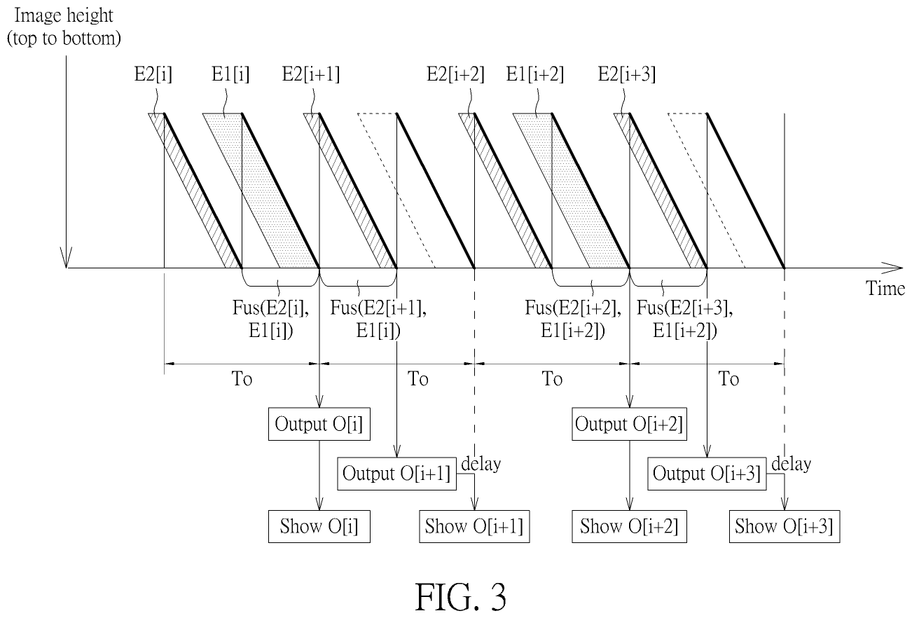

Please refer to FIG. 2 and FIG. 3. FIG. 3 is a diagram of showing the image streams with different frame rates and different exposure settings according to a first embodiment of the present invention. The first embodiment can be applied for the high-speed camera sensor 14, and interleaved control of the exposure settings can satisfy frame requirement input by the HDR video technology. For the asymmetric image fusion method, step S100 and step S102 can be executed to acquire a first image stream E1 with a first frame rate and a second image stream E2 with a second frame rate different from the first frame rate. In the first embodiment, the second image stream E2 can be set as the base exposure setting, and the second frame rate of the second image stream E2 can be equal to an output frame rate of the output image stream O. Parameter i can be indicated as the i-th image frame in the image stream. Therefore, an exposure setting of the first image stream E1 can be the reference exposure setting different from the base exposure setting of the second image stream E2.

Then, step S104 can be executed to fuse a first reused image frame E1[i] of the first image stream E1 with a set of second image frames E2[i] and E2[i+1] of the second image stream E2 respectively for outputting a set of fused image frames O[i] and O[i+1]. After that, step S106 and step S108 can be executed to fuse another first reused image frame E1[i+2] of the first image stream E1 with another set of second image frames E2[i+2] and E2[i+3] of the second image stream E2 respectively for outputting another set of fused image frames O[i+2] and O[i+3], and further to combine the fused image frames O[i] and O[i+1] with the fused image frames O[i+2] and O[i+3] to provide the output image stream O. The first reused image frame E1[i] and the first reused image frame E1[i+2] are both from the first image stream E1, so that a reused frequency of the first reused image frame E1[i] can be the same as a reused frequency of the another first reused image frame E1[i+2], and can be represented as the first image stream E1 has the stable first frame rate.

As the first embodiment shown in FIG. 3, the tilted line from top to bottom can be interpreted as exposure time of each image frame, so that a parameter To can indicate a time difference from the beginning of each second image frame E2 to the end of the related first reused image frame E1. The first reused image frame E1[i] can be fused with a current second image frame E2[i] to output and immediately show the current fused image frame O[i], and the first reused image frame E1[i] can be further fused with a following second image frame E2[i+1] to output the following fused image frame O[i+1], and the following fused image frame O[i+1] can be delayed for a predefined period to show so as to keep the fused image frames O[i] and O[i+1] are shown in uniform time interval.

Accordingly, the first reused image frame E1[i+2] can be fused with the current second image frame E2[i+2] to output and immediately show the current fused image frame O[i+2], and the first reused image frame E1[i+2] can be further fused with the following second image frame E2[i+3] to output the following fused image frame O[i+3], and the following fused image frame O[i+3] can be delayed for the predefined period to show so as to keep the fused image frames O[i+2] and O[i+3] are shown in the uniform time interval. The predefined period may be computed as time difference between an ending point of time of the first reused image frame E1[i] and an ending point of time of the current second image frame E2[i]. The first image stream E1 can have less image frames than the second image stream E2.

If the first embodiment is applied to the 3-exposure fusion, the asymmetric image fusion method can further acquire a third image stream with a third frame rate different from the first frame rate of the first image stream E1 and the second frame rate of the second image stream E2. When the second image stream E2 is still set as the base exposure setting, the first reused image frame of the first image stream E1 and a third reused image frame of the third image stream can be fused with the second image frames of the second image stream E2 respectively to output the fused image frames, and a reused frequency of the first reused image frame can be preferably different from a reused frequency of the third reused image frame. For example, the fused image frame can be generated as follows:

$$\begin{matrix}O [ i ] = Fus ( E 0 [ i ] , E 1 [ i ] , E 2 [ i + 2 ] ) \\ O [ i + 1 ] = Fus ( E 0 [ i ] , E 1 [ i + 1 ] , E 2 [ i + 2 ] ) \\ O [ i + 2 ] = Fus ( E 0 [ i + 2 ] , E 1 [ i + 2 ] , E 2 [ i + 2 ] ) \\ O [ i + 3 ] = Fus ( E 0 [ i + 2 ] , E 1 [ i + 3 ] , E 2 [ i + 5 ] ) \\ O [ i + 4 ] = Fus ( E 0 [ i + 4 ] , E 1 [ i + 4 ] , E 2 [ i + 5 ] ) \\ O [ i + 5 ] = Fus ( E 0 [ i + 4 ] , E 1 [ i + 5 ] , E 2 [ i + 5 ] )\end{matrix}$$

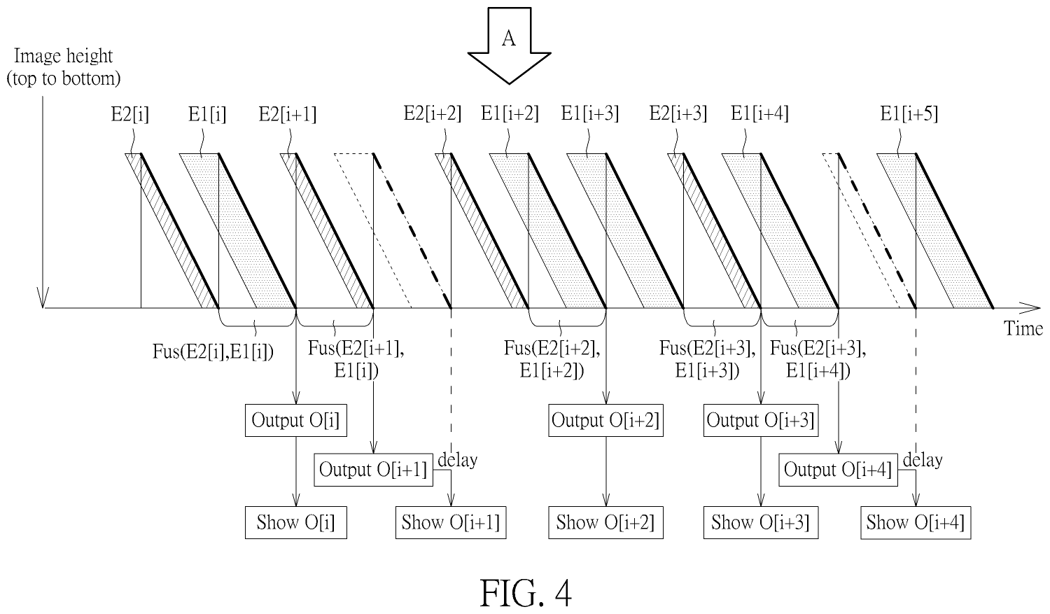

In some possible situation, the base exposure setting may be triggered and changed by scene change detected, setting changed by the user, camera vibration detected, and so on when video streaming, which means some event may trigger the base exposure setting from the second image stream E2 to the first image stream E1. Please refer to FIG. 4. FIG. 4 is a diagram of showing the image streams with different frame rates and different exposure settings according to a second embodiment of the present invention. The second embodiment can be applied for the high-speed camera sensor 14. The first frame rate of the first image stream E1 can be changed to be equal to the output frame rate of the output image stream O at a specific point of time, and the second frame rate of the second image stream E2 can be changed to be different from the output frame rate of the output image stream O at the same point of time.

As shown in FIG. 4, the second image stream E2 can have the base exposure setting and the first image stream E1 can have the reference exposure setting for a start, so the first reused image frame E1[i] can be fused with the second image frames E2[i] and E2[i+1] to output the fused image frames O[i] and O[i+1]; the fused image frame O[i] is output and shown immediately, and the fused image frame O[i+1] may be shown after delaying the predefined period. Then, the first image frame E1[i+2] are fused with the second image frame E2[i+2], and the base exposure setting is triggered and changed to the first image stream E1. Then, a trigger to change (for example, change the base exposure setting to the first image stream E1) is received at the time indicated by an arrow A, the first image frame E1[i+3] can be received before a second reused image frame E2[i+3], and the second reused image frame E2[i+3] can be fused with the first image frame E1[i+3] and the first image frame E1[i+4] respectively for outputting the fused image frames O[i+3] and O[i+4]; the fused image frame O[i+3] is output and shown immediately, and the fused image frame O[i+4] can be shown after delaying the predefined period.

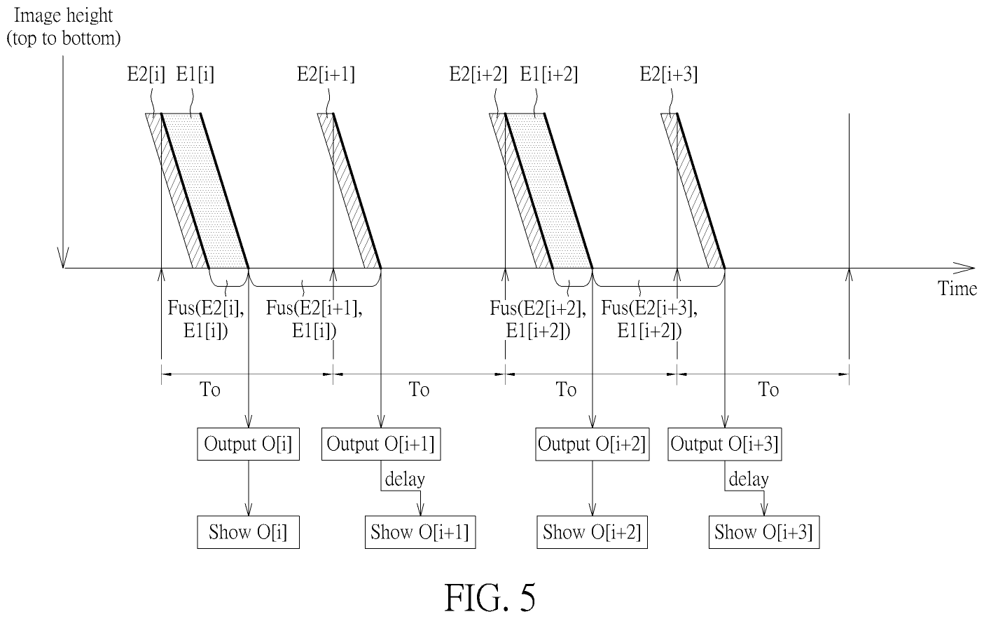

Please refer to FIG. 5. FIG. 5 is a diagram of showing the image streams with different frame rates and different exposure settings according to a third embodiment of the present invention. The third embodiment can be applied for the group exposure setting camera sensor 14, which has the group exposure setting designed for HDR. The third embodiment applied to the group exposure setting camera sensor 14 can change a number of the captured image frames in each group. The second image stream E2 can be selected as the base exposure setting, and the first image stream E1 can be selected as the reference exposure setting. The first reused image frame E1[i] can be fused with the second image frame E2[i] to output the fused image frame O[i], and then the first reused image frame E1[i] needs to be buffered for fusing with the second image frame E2[i+1] to output the fused image frame O[i+1]; the fused image frame O[i] is output and shown immediately, and the fused image frame O[i+1] may be shown after delaying the predefined period. Further, the first image frame E1[i+2] can be fused with the second image frames E2[i+2] and E2[i+3]; the fused image frame O[i+2] is output and shown immediately, and the fused image frame O[i+3] may be shown after delaying the predefined period.

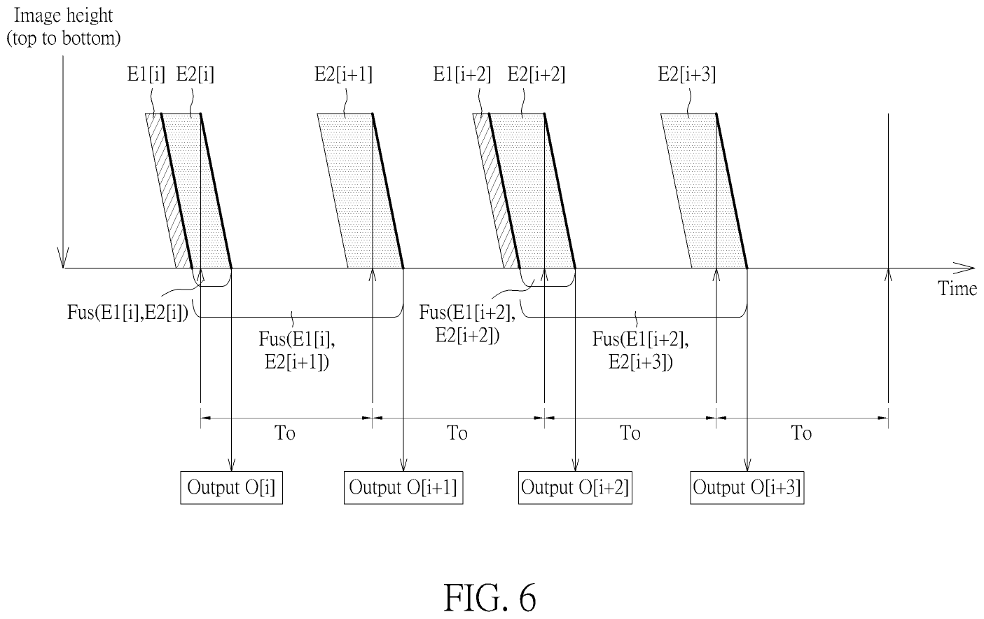

Please refer to FIG. 6. FIG. 6 is a diagram of showing the image streams with different frame rates and different exposure settings according to a fourth embodiment of the present invention. The fourth embodiment can be applied for the group exposure setting camera sensor 14. As shown in FIG. 6, the second image stream E2 which has the second exposure of the group setting can be selected as the base exposure setting, and the first image stream E1 can be selected as the reference exposure setting; the frame synchronous timing is set to the read-out timing of second image stream E2 for keep the interval between the captured image frames equally. Besides, the base exposure setting of the second image stream E2 can be changed because auto-exposure (AE) control may cause the exposure setting dynamically change. The first reused image frame E1[i] can be fused with the second image frames E2[i] and E2[i+1] to output the fused image frames O[i] and O[i+1]. Because the read-out timing of the second image stream E2 is the captured synchronous timing, the AE control does not change timing of the fused image frame, so the fused image frames O[i] and O[i+1] can be output and show immediately. Motion of the fused image frames O are aligned to the second image stream E2 with the base exposure setting.

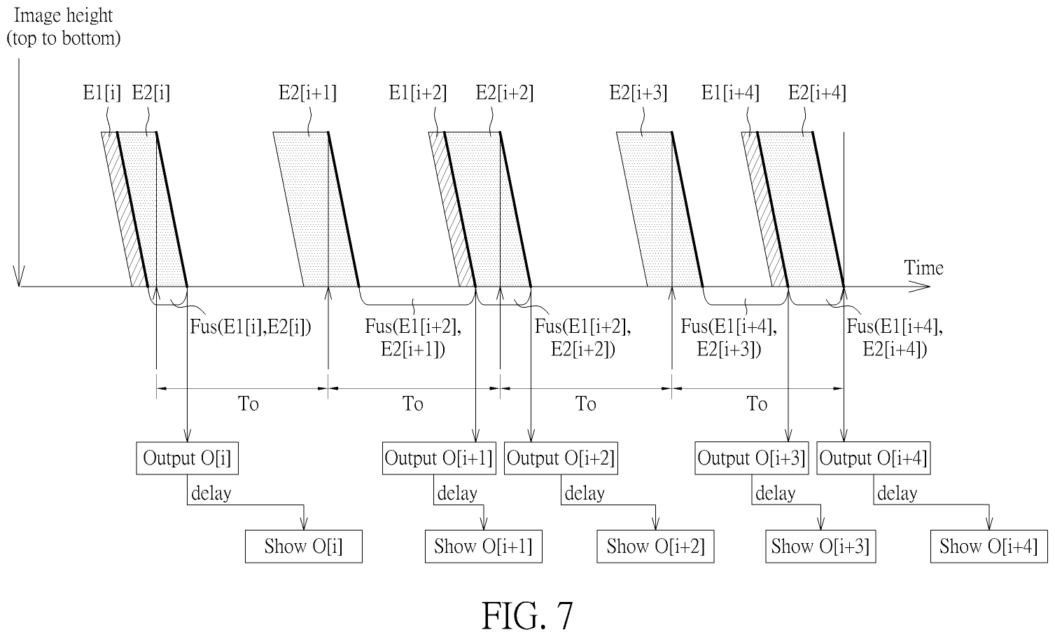

Please refer to FIG. 7. FIG. 7 is a diagram of showing the image streams with different frame rates and different exposure settings according to a fifth embodiment of the present invention. The fifth embodiment can be applied for the group exposure setting camera sensor 14. The second image stream E2 which has the second exposure of the group setting can be selected as the base exposure setting, and the first image stream E1 can be selected as the reference exposure setting. In the fifth embodiment, the reused image frame can be shared forward instead of the backward example as mentioned above. The previous second image frame E2[i+1] can be buffered to wait the first reused image frame E1[i+2] being captured, and then the first reused image frame E1[i+2] can be fused with the previous second image frame E2[i+1] to output the previous fused image frame O[i+1], and the first reused image frame E1[i+2] can be further fused with the current second image frame E2[i+2] to output the current fused image frame O[i+2]. The asymmetric image fusion method may delay a short predefined period to show the previous fused image frame O[i+1], and delay a long predefined period to show the current fused image frame O[i+2]. Therefore, all the fused image frames can be buffered to control the display speed of the output image stream O because the AE control may change the timing of the first image stream E1.

In conclusion, the asymmetric image fusion method and the related operation device of the present invention can acquire at least two image streams with different frame rate and different exposure settings. Each reused image frame of the image stream that is set to the reference exposure setting can be fused with several image frames of the image stream that is set to the base exposure setting for providing the output image stream. For example, the first image stream may have 15 frames per second (fps) and the second image stream may have 30 fps; the second frame rate of the second image stream must keep the same frame rate as display requirement of the output image stream. Therefore, the even or odd indexing of the first reused image frame can be shared and fused with the corresponding second image frames to produce the fused image frames of the output image stream. The number of the first image frames can be reduced to economize the power consumption of sensing, transmission or storing the captured image frames.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An asymmetric image fusion method, comprising:
acquiring a first image stream with a first frame rate;
acquiring a second image stream with a second frame rate different from the first frame rate; and
fusing a first reused image frame of the first image stream with a set of second image frames of the second image stream respectively for outputting a set of fused image frames.

2. The asymmetric image fusion method of claim 1, further comprising:
fusing another first reused image frame of the first image stream with another set of second image frames of the second image stream respectively for outputting another set of fused image frames; and
combining the foresaid sets of fused image frames to provide an output image stream.

3. The asymmetric image fusion method of claim 2, wherein the second frame rate of the second image stream is equal to an output frame rate of the output image stream.

4. The asymmetric image fusion method of claim 1, wherein the first frame rate is variable.

5. The asymmetric image fusion method of claim 1, wherein an exposure setting of the first image stream is different from an exposure setting of the second image stream.

6. The asymmetric image fusion method of claim 5, further comprising:
adjusting the exposure setting of the first image stream of the second image stream in a dynamically controlling manner.

7. The asymmetric image fusion method of claim 1, wherein a reused frequency of the first reused image frame is the same as a reused frequency of the another first reused image frame.

8. The asymmetric image fusion method of claim 1, further comprising:
acquiring a third image stream with a third frame rate different from the first frame rate and the second frame rate; and
fusing the first reused image frame of the first image stream and a third reused image frame of the third image stream with the set of second image frames of the second image stream respectively for outputting the set of fused image frames.

9. The asymmetric image fusion method of claim 8, wherein a reused frequency of the first reused image frame is different from a reused frequency of the third reused image frame.

10. The asymmetric image fusion method of claim 1, further comprising:
fusing the first reused image frame with a current second image frame of the set of second image frames to output a current fused image frame of the set of fused image frames; and
fusing the first reused image frame with a following second image frame of the set of second image frames to output a following fused image frame of the set of fused image frames and delaying for showing the following fused image frame after a predefined period.

11. The asymmetric image fusion method of claim 10, wherein the predefined period is time difference between an ending point of time of the first reused image frame and an ending point of time of the current second image frame.

12. The asymmetric image fusion method of claim 1, further comprising:
fusing the first reused image frame with a previous second image frame of the set of second image frames to output a previous fused image frame of the set of fused image frames and delaying for showing the previous fused image frame after a predefined period; and
fusing the first reused image frame with a current second image frame of the set of second image frames to output a current fused image frame of the set of fused image frames and delaying for showing the current fused image frame after another predefined period.

13. The asymmetric image fusion method of claim 1, further comprising:
changing the first frame rate to be equal to an output frame rate of the output image stream;
changing the second frame rate to be different from the output frame rate; and
fusing a second reused image frame of the second image stream with a set of first image frames of the first image stream respectively for outputting other set of fused image frames.

14. An operation device with an asymmetric image fusion function, comprising:
an operation processor electrically connected with an image sensor to acquire a first image stream with a first frame rate and a second image stream with a second frame rate different from the first frame rate, and adapted to fuse a first reused image frame of the first image stream with a set of second image frames of the second image stream respectively for outputting a set of fused image frames.
